(19) United States
(12) Patent Application Publication
(10) Pub. No.: US 2004/0094929 A1
(43) Pub. Date: May 20, 2004

(54) Vehicle having interconnected suspensions

(76) Inventor: Valentino Ribi, Montreux (CH)

Correspondence Address: James C Wray, Suite 300, 1493 Chain Bridge Road, McLean, VA, 22101, US

(21) Appl. No.: 10/468,806

(22) PCT Filed: Feb. 22, 2002
(86) PCT No.: PCT/IB02/00545

(30) Foreign Application Priority Data
Feb. 23, 2001 (CH) 362/01

(51) Int. Cl. B60G 11/26

(52) U.S. Cl. 280/124.161

(57) ABSTRACT

The invention relates to a vehicle for carrying persons and/or cargo. This vehicle comprises an automotive frame having at least two wheels (2), which are disposed on opposite sides of the vehicle with reference to the longitudinal axis, or substanntially aligned along the longitudinal axis of the vehicle, and are provided with elastic suspensions, which are driven by any type of kinematic system, composed by at least one elastic element (103, 105) of any type. The vehicle is characterized in that the suspensions of the individual wheels are connected with each other by means of any mechanical, hydraulic, pneumatic, electrical or magnetic system or any combination thereof, at least one elastic element (105) acting thereon, and in that the reaction to the stress exerted by one of the connected wheels transfers, at least partly, a stress on the corresponding connected wheel/s and in that elastic opposing elements (103) are provided on each wheel.

The invention relates to a vehicle comprising an automotive frame or chassis having at least two wheels, which are disposed on opposite sides of the vehicle with reference to the longitudinal axis oriented in the vehicle driving direction, or substantially aligned along the longitudinal axis of the vehicle, and have suspensions driven by any kinematic system, composed of any type of elastic elements simultaneously acting, directly or indirectly, on said wheels so that the latter are interdependent.

Traditional vehicles of this type are known, in which the suspensions of the vehicle wheels are independent from each other.

In prior art vehicles, any motion of the individual wheels, or non suspended masses, which follow road bumps, transfers to the chassis or suspended mass, via the suspensions, forces which are proportional to the stiffness of the elastic elements of the individual wheels, to speed and to the ratio between suspended and non suspended masses. In order to achieve a good comfort level as well as a good vehicle stability, the current tendency is to reduce the stiffness of the elastic elements and to rebalance the vehicle, with the help of anti-roll bars and other kinematic arrangements.

Nevertheless, these arrangements reduce comfort and stability.

This invention is aimed at reducing the stiffness improving load distribution, reducing ground impact, improving traction, and even reducing the energy absorbed by the suspensions, which also reduces consumption.

Although the terms used in the art are known, the most common terms will be now defined for the sake of clearness:

Hunting will be intended as the motion of the vehicle along the vertical axis passing through the center of gravity thereof, rolling will be the rotary motion of the vehicle about the horizontal longitudinal axis passing through the center of gravity of the vehicle, whereas pitching will be the rotary motion of the vehicle about the horizontal axis perpendicular to the longitudinal axis or transverse axis. The other characteristic movements of the vehicle are yaw, i.e. the rotation of the vehicle about the vertical axis passing through the center of gravity and side-slipping, which is the lateral translational motion along the horizontal axis perpendicular to the longitudinal axis of the vehicle.

The forward motion of the vehicle does not generally cause any significant vibration, neither does the side slipping motion, which only occurs at speeds near the tire adhesion limit. Oscillations associated to yaw are also only critical in limit drive conditions and basically depend on the stiffness of suspensions and on the damping capacity of shock absorbers, therefore they must be carefully controlled for safety purposes.

Another important situation is traction, which is essentially a function of the coefficient of adhesion, as well as of load distribution among wheels and of the average load thereof on the ground. Particularly in bad grip conditions, driving wheels transfer to the ground a force which is proportional to the number of driven wheels and to the force of the wheel having the worst grip. As a result, in case of a great difference of load on the driving wheels, the vehicle has a poor acceleration or no acceleration at all. Typically, this is due to the fact that, if a wheel passes over a bump, its load increases, as the load on the other wheels decreases and, as mentioned above, traction decreases proportionally.

The same effect is generated on roadholding stability, whereby, if roadholding of one of the external wheels decreases, due to a lower load with respect to the other, a momentum is generated which causes, for instance, a yaw motion.

In view of the vehicle comfort and in normal conditions, the oscillatory motions to be considered are hunting, pitching and rolling. Comfort involves the tendency to have a very low stiffness of suspensions with as high a ratio as possible between the suspended and the non suspended masses, without affecting weight and total inertia of the vehicle, whereas safety involves the tendency to a definitely high stiffness of suspensions and minimized total weight and inertia.

In prior art devices, these hunting, pitching and rolling motions especially occur in suspension stress conditions, as the vehicle moves, due to the presence of discontinuities and obstacles on the ground. This may cause, in particularly difficult situations, such as in wet ground conditions and/or in curve road lengths, bad load distribution on the wheels, which causes a loss of grip on the ground and, in some cases, vehicle control loss, with consequent side slip and/or yaw motions.

The width and frequency of oscillatory motions mainly depend on the physical characteristics of the motor vehicle: particularly on suspended mass, non suspended mass, on elastic constants of suspension elastic elements, on tire elastic constants, on damping factors of shock absorbers and on damping factors of tires.

Therefore, driving safety and comfort are affected by the characteristics of suspensions and by the ratio between the weight of non suspended masses and that of suspended masses.

Moreover, for instance in work or transportation vehicles, which have to carry considerable loads and are provided with three or more pairs of wheels, having traditional suspensions, and are used in particular conditions, i.e. on roads having high bumps, such as in off-road conditions, one or more wheels may lose contact with the ground, as a function of speed and of the type of obstacles, with a consequent loss of stability of the vehicle. This is an even more serious condition if the wheel/s that lose contact with the ground are driving and/or steering wheels, since this might cause the driver to lose control of the vehicle and/or to get stuck in the mud.

An additional drawback of prior art vehicles, due to the fact that suspensions are directly connected to the vehicle frame or suspended mass, hinders the possibility to uncouple frame motion from wheel motion, and this causes, in addition to the more serious drawbacks described above, an imperfect comfort of the vehicle. Whenever the vehicle passes through grounds having swells or discontinuities, efforts are generated, i.e. movements which are transferred to the vehicle frame, to the driver and to any passenger, and this causes a decrease in vehicle comfort. Moreover, in the case of a cargo-carrying vehicle, these movements may involve in the worst cases cargo displacements which might also cause a loss of control of the vehicle.

In vehicles with traditional suspensions, it is apparent that oscillations and movements of suspended masses cannot be controlled, because vehicle suspensions are independent from each other and directly connected to suspended masses. In order to limit stresses both in the suspension system and in the structure of the whole vehicle, the suspended mass should have as little weight as possible, compatibly with the other construction needs.

In fact, suspended masses form the greater percentage of the vehicle mass and, since inertia forces are proportional to the mass, it is apparent that stresses caused by these forces may be limited by reducing suspended masses or by providing systems in which the vehicle frame and wheels are essentially uncoupled.

The invention is based on the problem of providing a vehicle as described hereinbefore, in such a manner as to obviate the above mentioned drawbacks of prior art devices by using simple, inexpensive and safely operating arrangements, while providing the suspension system with additional features which are not currently available on traditional suspensions.

The invention achieves the above purposes by providing a vehicle like the one described herein, in which elastic suspensions are connected to each other through any mechanical or hydraulic or pneumatic or electromagnetic system, which transfers at least partly the load stresses acting on a wheel on its respective connected wheel or on its respective connected wheels.

For a better understanding of the following disclosure and claims, the technical terms in use in the disclosure and claims will be defined hereafter:

The term shock absorbing elements also includes, besides traditional shock absorbers, systems that are placed on the connection and interconnection links having adjustable valves and/or systems with reeds or other electrical, electromagnetic, mechanic, or physical flow control systems, for controlling the damping action as a function of speed, frequency of oscillations, accelerations, or other dynamic parameters of the vehicle.

The term Interconnection shall refer to any mechanical, hydraulic, electrical means which, upon an action of a wheel causes an action on one or more other connected wheels and vice versa.

The term chassis/frame relates to the non suspended mass of the vehicle including cargo and/or passengers.

Vehicle shall mean a person and cargo carrying means.

The axle is the supporting member between two wheels which is parallel to the drive direction of the vehicle.

Fluid shall mean any compressible, uncompressible, gelatinous, gaseous liquid, including liquid silicone.

Actuator shall refer to a single or double acting component which performs a movement, or exerts a force, and may be of hydraulic, pneumatic, electric, magnetic, mechanical type or a combination thereof.

The term valve shall include any type of fluid flow control with on-off variations to continuous and calibrated variations, and valves may have manual, mechanical, hydraulic, pneumatic, electric, magnetic controls, or a combination thereof.

The prefix Hydro shall identify an incompressible fluid.

The term elastic element shall mean any elastically reacting body, such as springs, gases, compounds, foams, rubber, made of a compressible, metal or composite material, and being flexible, of any shape or structure, including reactions with magnetic or electric forces.

Non suspended mass shall refer to the wheels with tires and a part of the kinematic system including suspensions, brakes and all elements downstream from elastic supporting elements.

The term compressor shall mean a system that compresses the elastic fluid and may be controlled by power or passively by the suspension movement.

Temperature control (referred to compressible fluids whose pressure is a function of temperature) may be obtained by means of any sensor which may correct directly or indirectly a thermal energy flow, e.g. from an electric source or utilize the thermal energy of the vehicle engine.

The word opposed or opposing element refers to an elastic element in opposition to another elastic element, i.e. to the condition wherein the two forces are subtracted from each other whereas stiffness values are summed; in particular, opposing elements are opposed to vehicle supporting elements.

The suspension system according to the invention is aimed at essentially uncoupling non suspended masses from suspended masses. In fact, all stresses due to ground bumps and discontinuities encountered by the vehicle on its motion, which cause the hunting, pitching, and rolling motions of suspended masses are considerably attenuated by appropriately exerting forces on suspended masses through vehicle suspensions. The interconnection allows to discharge a portion of the stress exerted on a wheel onto one or more oth r wheels interconnected with it. This feature has the advantage to combine comfort and safe attitude which, as described above, are two suspension behavior characteristics that can be only obtained by antithetical or contrasting arrangements in traditional suspension systems, i.e. the one by a stiffness decrease and the other by a stiffness increase.

The interconnection principle according to the invention may be applied either alternatively or in combination both to anti-pitch systems and to anti-roll systems, as well as to attitude control systems designed for dynamic behaviors of the vehicle in particular conditions, e.g. when braking or cornering.

The invention is also aimed at suggesting, both in principle and by means of a construction example, a few embodiments which provide further different features.

The suspension system of the invention may be implemented in several different manners, which will form the subject of the following detailed description. The functional advantages deriving from the invention will also be described in greater detail in the following description.

These are especially due to the fact that the vehicle suspensions allow to obtain a controlled distribution of forces over the suspended mass of the vehicle.

For instance, vehicle suspensions in the simplest embodiment may include an elastic element, for supporting the vehicle weight, which acts directly or indirectly on an interconnection system between at least two wheels and an elastic opposing system, preferably of the pneumatic type, which acts individually on each wheel, to improve rolling and/or pitching stability. The shock absorbing element may be constructed according to any type of braking system which acts directly or indirectly on the elastic elements to dampen oscillations and stabilize the vehicle. Vehicle stabilization may be obtained through a preferably electronic system, connected to the suspension system by appropriate vehicle oscillation measurement sensors. These sensors, which are provided with a special connection interface, send the detected signals to an electronic processor for further processing, to obtain the correction and/or improvement actions to be sent to the suspension actuator elements of the vehicle, by any system interfaced with the electronic computer, which causes the change of constants and physical parameters of the elastic elements and/or shock absorbers. The actuator system may be, for instance, of the mechanical, or hydraulic, or pneumatic or electric or magnetic type or a combination thereof, depending on the type of connections and of the elements used in the vehicle. The corrective actions sent by the electronic computer to actuators via an appropriate interface may be automatically determined by the computer thanks to programs for calculating the vehicle dynamics from motion equations, while accounting for the physical characteristics of the vehicle, ground conditions, the desired comfort conditions and other useful parameters, or be manually preset by the driver.

By connecting the suspensions (elastic elements and shock absorbers) of the vehicle to each other, through the electronic system formed by the computer, the sensors and actuators, the oscillatory movements of suspended masses are essentially independent from the forward motion of the vehicle and from ground conditions, whereby the possibility to lose control of the vehicle is minimized.

According to an improvement of the invention, the control of the oscillatory rolling motion of the vehicle may be provided by means of a suspended mass suspension system which uses pneumatic or hydraulic anti-roll bars, formed by two double acting linear actuators, connected in series or in parallel to the suspensions. Each of these double acting linear actuators consists of a cylinder connected to the frame and, directly or indirectly, to the hub of the vehicle wheels and containing a moving piston. Hence, the cylinder is divided into two chambers by the piston, a pressurized fluid being provided in each of these chambers. The pressure force of the fluid in the wheel side chamber of the cylinder is exerted on the opposing piston wall, and that in the other chamber supports the vehicle weight. Each chamber of each actuator is connected by means of ducts to the chamber of the other actuator in an inverted fashion, so that the compression of an actuator causes a corresponding movement in the other actuator.

In another version of vehicle suspensions according to the invention, the anti-roll bars formed by the two double acting linear actuators as described above may be cross-connected. In this case, the double acting linear actuator placed on a front side of the vehicle is connected with the double acting linear actuator placed on the rear side of the vehicle, opposite to the first actuator, and the same is provided for the other two front and rear double acting linear actuators.

The suspended mass oscillation damping system which uses fluid hydraulic anti-roll bars has the apparent advantage that it can be used in combination with or alternatively to traditional suspensions, without making any substantial change to the vehicle. In fact, this type of device may be provided instead of traditional suspension shock absorbers. This is only possible if fluid dynamic brakes are also provided on the connection ducts of linear actuator chambers, which provide the load losses in the fluid flow required to cause the desired suspended mass oscillation damping effect. Hence, old construction vehicles may be also provided with a suspension system which, thanks to the invention, may be manufactured in a simple and inexpensive manner.

In order to obtain a better control and damping effect on vehicle suspended mass oscillations, the elastic elements of suspensions are also interconnected through an interconnection system. For instance, the elastic element interconnection system may consist of a hydraulic circuit with the oscillation damping elements or shock absorbers acting on said circuit. In this case, both the elastic element which opposes vehicle weight supporting forces and the vehicle weight supporting element itself may be of the pneumatic type.

The advantage of having fluid dynamic elastic elements consist in that a fluid pressure control system may be applied to the connection circuit between these elements or to the elements themselves, which system acts via a pump or a compressor or a temperature variation system. The pump or compressor is preferably controlled by sensors and actuators interfaced with an electronic system, which controls one or more vehicle weight supporting and/or opposing pressures, to adjust the vehicle level and/or its inclination with respect to the ground, the stiffness of one or more of the elastic vehicle weight supporting and/or opposing elements.

Therefore, the vehicle may be adapted to the various drive conditions, while driving, either manually or electronically and in real time, from high comfort to sports drive or off-road conditions, or to load or load distribution changes.

The physical characteristics of the elastic elements of the suspension system which uses oil pneumatic actuators may be changed by changing the volumes of the vehicle weight supporting or opposing chambers, by any type of mechanical or hydraulic or pneumatic or electromagnetic system, or a combination thereof. As an alternative to the vehicle weight supporting or opposing chamber volume variation system, adjustable valves may be inserted between the ducts for connecting the chambers of the elastic elements to change the section thereof. The section variation of one or more ducts, due to the presence of one or more valves, causes a variation of load losses in the duct, hence of the physical characteristics of the suspension system. Particularly, as the section of the connection ducts decreases, the suspension system is stiffened; further, the duct section decrease causes an increase of load losses with a consequent increase of the system damping factor.

In order to obtain a more accurate control on the characteristics of the suspension system, the pneumatic or hydraulic linear actuators or receivers with two chambers divided by a diaphragm may be provided with multiple chambers connected to each other by ducts. Adjustable valves and/or fluid dynamic brakes are provided on these ducts, to adjust the section thereof in such a manner as to vary the physical characteristics of the suspension system.

In order to obtain a complete control of all oscillatory motions of the vehicle, all vehicle suspensions are provided with double acting linear actuators, particularly having multiple chambers, in which the ducts connecting each chamber are connected in turn to a control valve system that can provide several or all interconnection possibilities between the various chambers.

Amongst the different possible control valve configurations, one is particularly provided in which the valves interconnect all the chambers whose actions support the vehicle, whereas the chambers that oppose the above actions are uncoupled or alternatively replaced by spring elements.

Another possibility to interconnect the chambers of fluid dynamic actuators by using control valves is the one in which, in any drive condition, interconnection is such as to minimize the impact of the vehicle on the ground. Therefore, the pressure exerted by each wheel connected to the suspension is substantially proportional to the ratio between the total weight of the vehicle and the number of suspensions and is anyway substantially lower than that of a traditional vehicle.

In accordance with an additional improvement, when only one suspension moves, the interconnection of the chambers of pneumatic or hydraulic linear actuators, by means of control valves, is such that the stiffness of the elastic element of a single suspension is proportional to the ratio between the stiffness of the elastic element of a traditional suspension (R) (not coupled with the others) and the total number of suspensions of the vehicle (N), i.e. R/N. In case of vertical oscillatory hunting or gravitational motions, which cause the movement of several interconnected suspensions, the stiffness of the elastic elements of the suspensions is proportional to the stiffness of an elastic element of a traditional suspension (not coupled with the others). The control valves are controlled by actuators that are in turn controlled by an electronic computer which processes the signals coming from special sensors. Hence, a complete control of oscillatory hunting, pitching and rolling motion is obtained. Obviously, when needed, the driver may set the main parameters to obtain the desired stabilization effect or may let the electronic computer make any decision. If the suspension system is of the pneumatic type, a temperature stabilization system may be introduced to obtain a better stabilization of the vehicle in any condition. This temperature control system may be interfaced with the suspension controlling electronic computer.

By controlling the temperature of the gas contained in the double acting linear actuators and in the connection ducts, a more accurate control of all physical constants of the suspension system may be obtained. The attitude correction due to the temperature change may be obtained by varying the pressure and/or volume of the chambers and/or by heating or cooling the fluids, e.g. by utilizing the thermal energy dissipated by the drive system or provided electrically or by using a system which utilizes the motion energy of suspensions. Another solution, which is particularly suitable for off-road and cargo vehicles having more than three axles, consists in interconnecting the wheels of each side of the vehicle and calibrating the stiffness of each suspension, for instance like traditional ones. Comfort will be the same as in the vehicle with traditional suspensions but the load of the vehicle, in the same suspension failure conditions will be multiplied by the number of connected suspensions, i.e. in the case of three axles, it will be three times as great. In conditions of low adhesion, traction is inversely proportional to the dynamic variation of the impact on the ground, i.e. much better for minimized impact vehicles.

The characteristics of the invention, as well as any possible improvement will form the subject of the dependent claims.

The characteristics of the invention and the advantages derived therefrom will appear more clearly from the following description of a few non-limiting embodiments, illustrated in the annexed drawings, in which

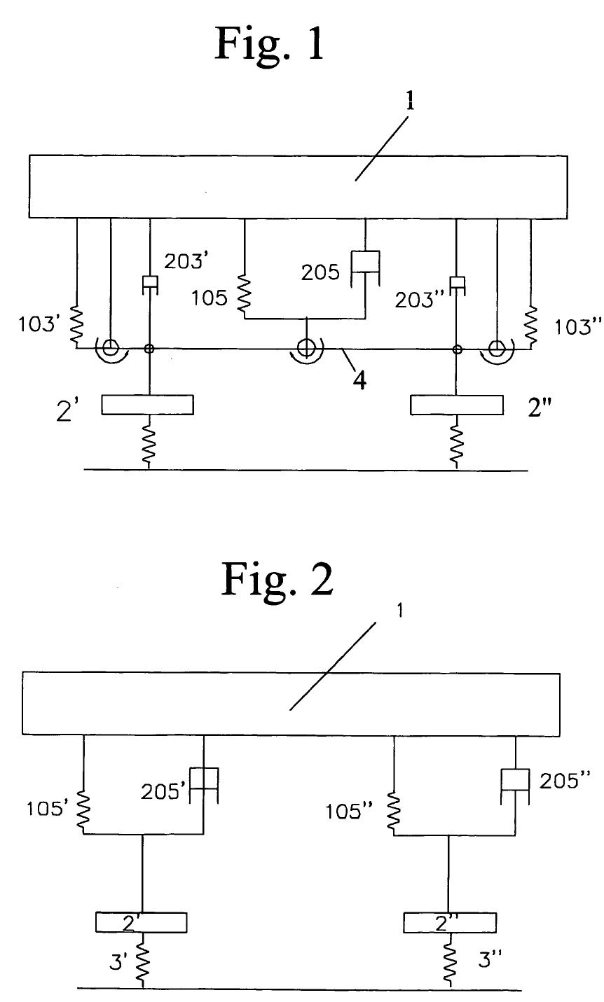

FIG. 1 is a basic scheme of the vehicle according to the invention.

FIG. 2 is a view like FIG. 1 of a vehicle according to prior art.

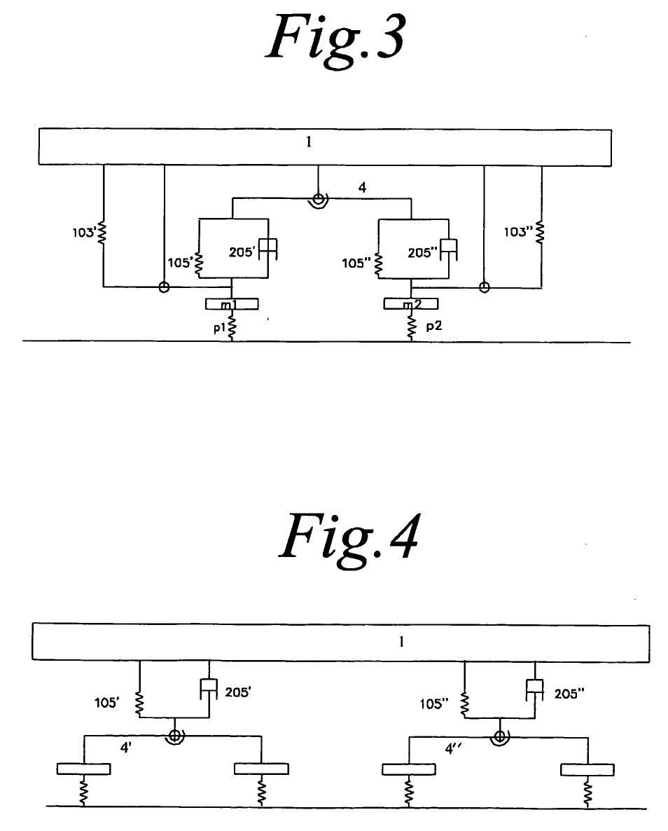

FIG. 3 is a view of a variant of the scheme as shown in FIG. 1.

FIG. 4 is a schematic view of the scheme as shown in FIG. 1 applied to an eight-wheel vehicle.

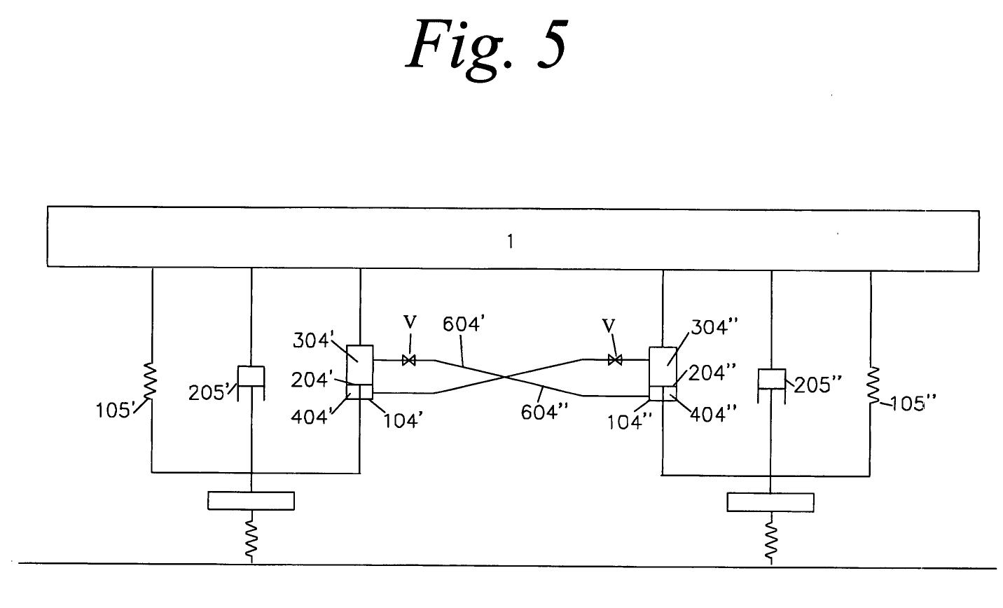

FIG. 5 is a schematic view of a vehicle according to the invention having a system of cross-interconnection of two wheels, i.e. in which an action on a wheel causes the same tendency on the corresponding interconnected wheel.

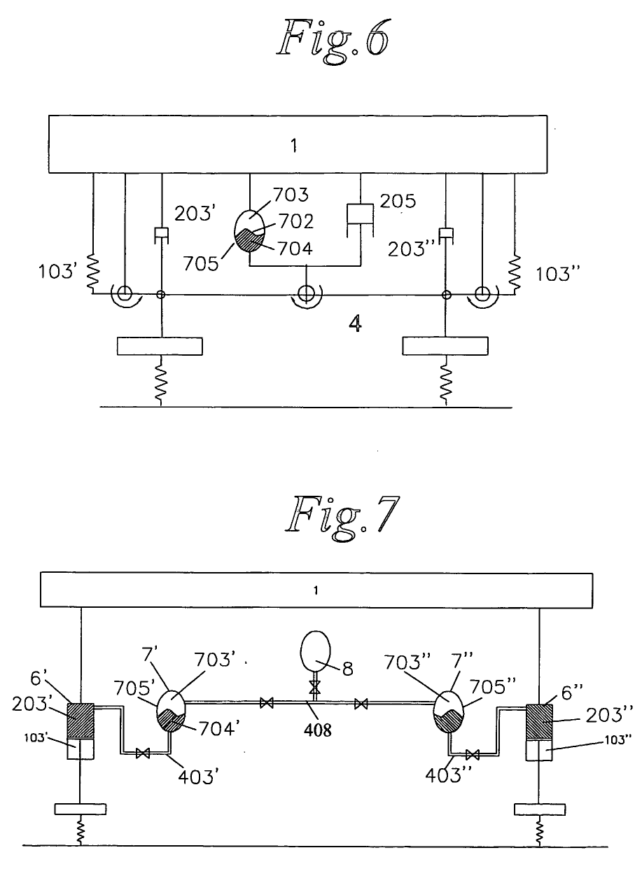

FIG. 6 is a schematic view of a variant embodiment of the vehicle of the invention in which the main actuator is a receiver having a diaphragm for dividing a liquid from a fluid.

FIG. 7 is a view of a variant embodiment of the scheme as shown in FIG. 3 in which an additional receiver is provided which changes stiffness depending on the connection, i.e. decreases stiffness by opening the valve for connecting the receiver to the suspension system.

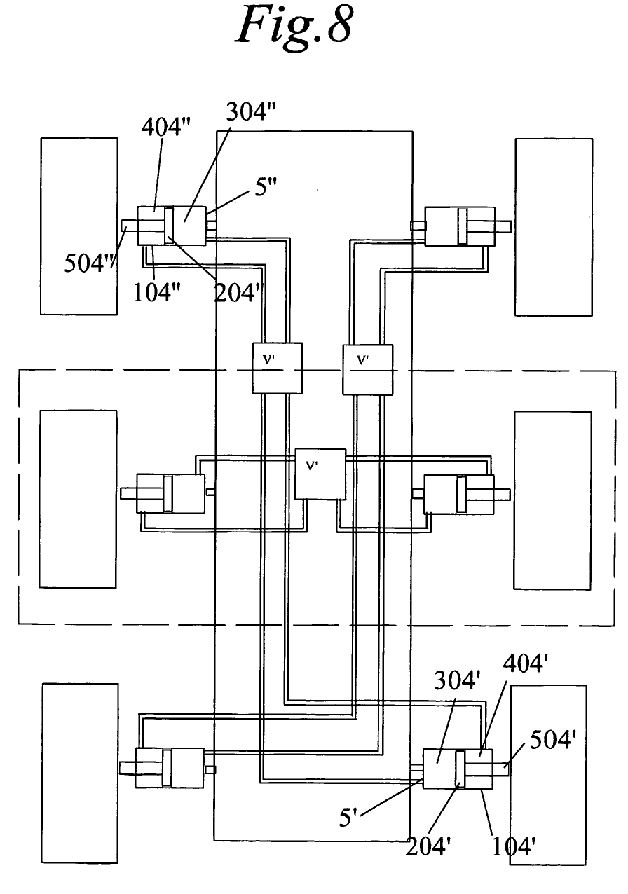

FIG. 8 is a schematic view of a vehicle according to the invention which is provided with a cross-front/rear anti-roll/pitch bar, and in which the axle within the dashed frame is to be intended as present or absent to mean a four-wheel vehicle or a six-wheel vehicle.

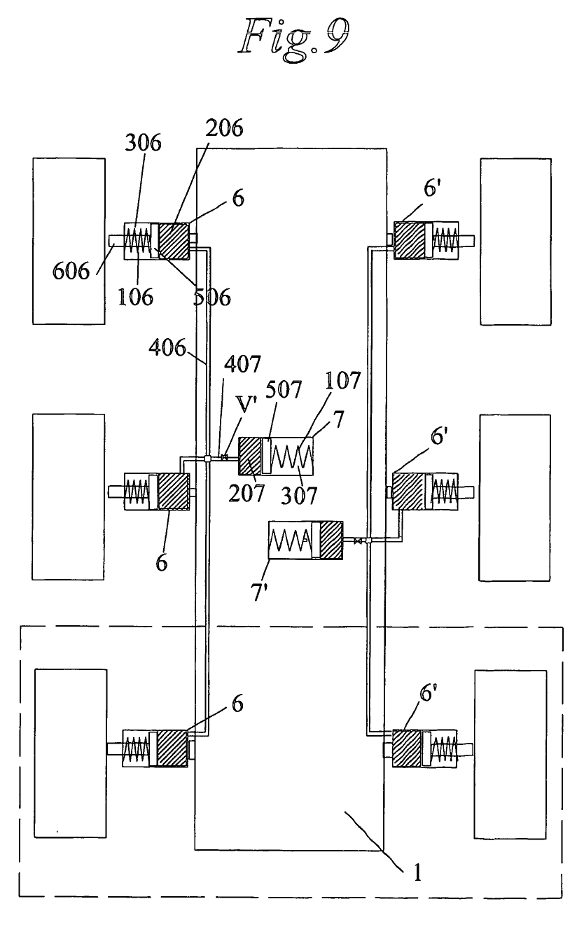

FIG. 9 is a schematic view of a vehicle according to the principle of FIG. 1 in which all the wheels of each vehicle side are interconnected, the axle within the dashed frame being provided or not provided depending on whether the vehicle has four or six wheels.

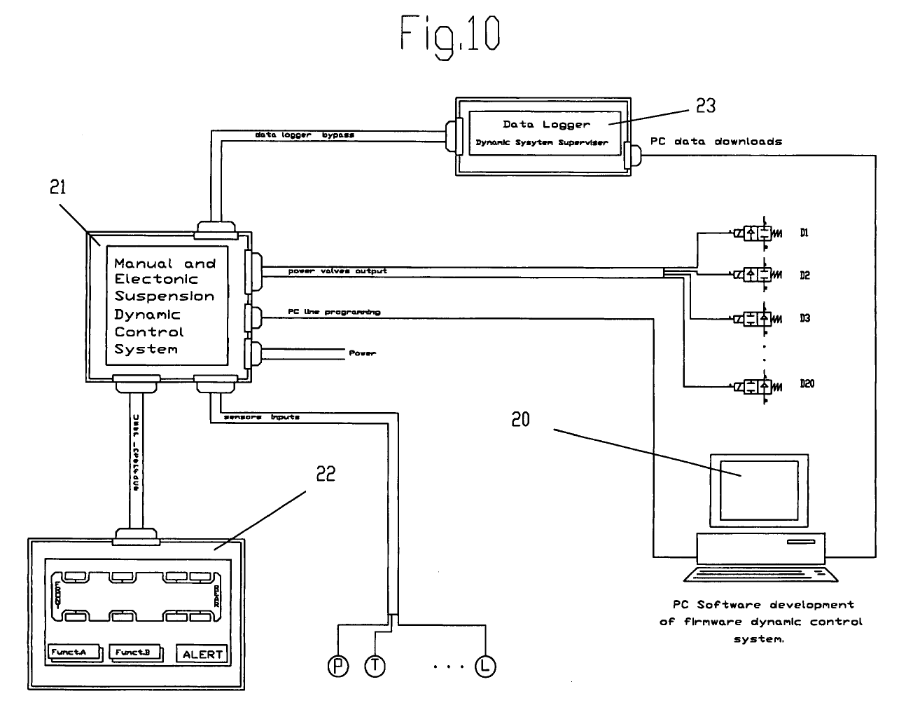

FIG. 10 is a block diagram of an electronic control system having sensor inputs, valve control and actuator outputs, motors, etc., as well as computer or microprocessor means for uploading and downloading data and actuation, control, adjustment, and diagnostic software.

FIG. 11 is a schematic view of a vehicle according to the invention having a complete system for an eight-wheel vehicle with several command and pressure control valves to also obtain, besides vehicle suspension control, an attitude variation, thanks to a compressor and to recycling of gas or fluid in the pneumatic circuit.

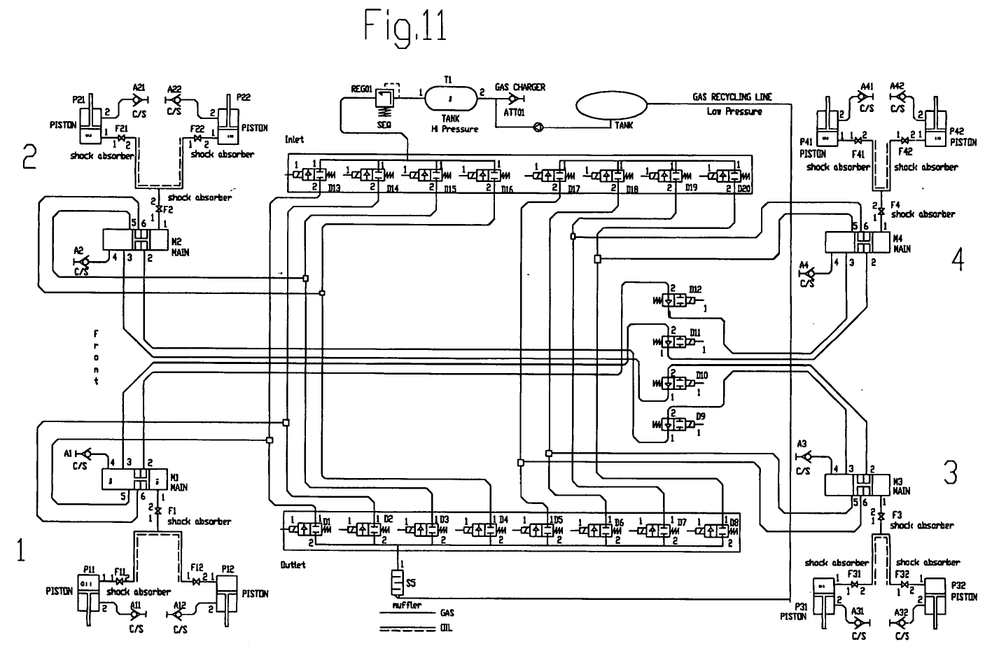

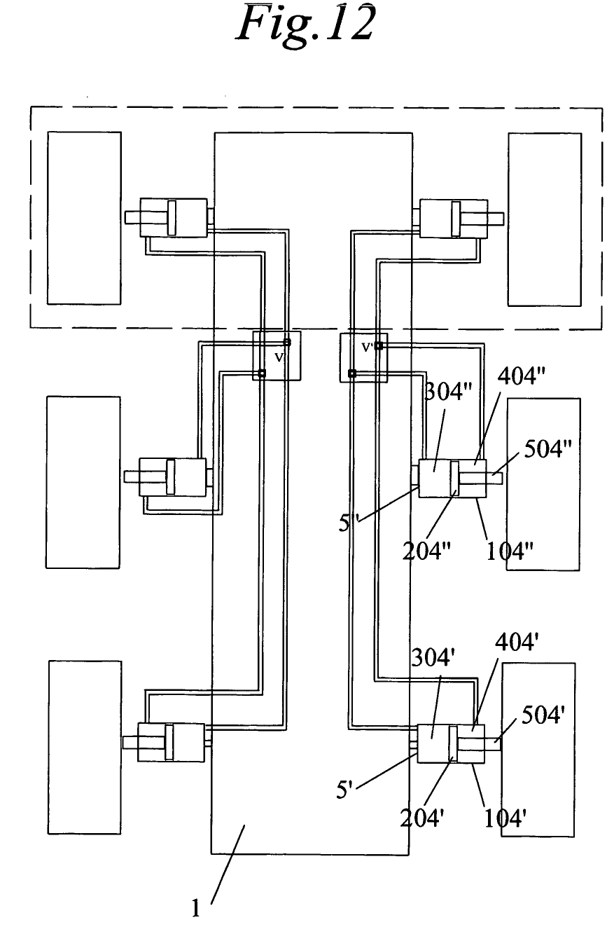

FIG. 12 is a schematic view of a vehicle according to the invention, which provides a side actuator/shock absorber interconnection, to be connected in series to a suspension system to obtain a lower rolling motion while keeping a low stiffness of each individual wheel.

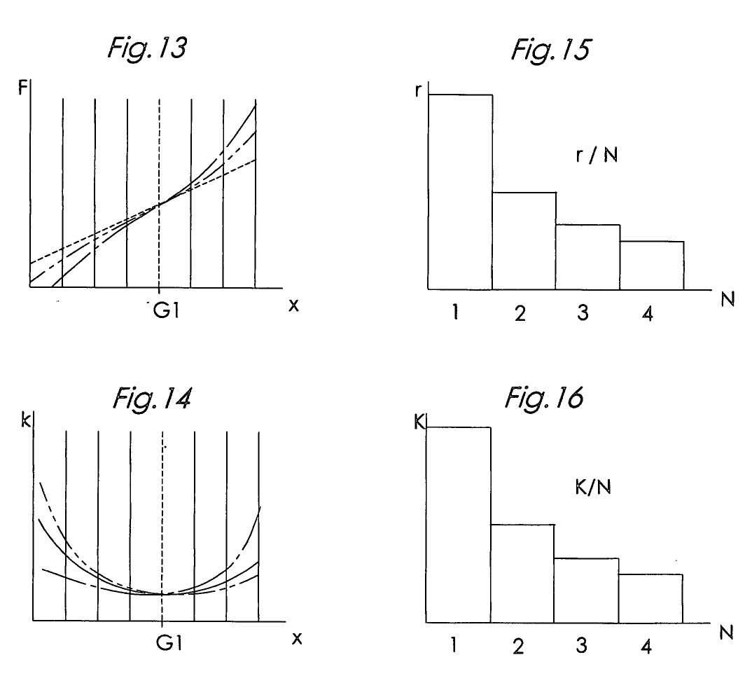

FIG. 13 is a view of the set of curves of the total elastic action exerted on the wheel, i.e. the sum of the elastic action of the support spring, of the contrast spring and of the elastic action spring of the anti-roll bar.

FIG. 14 is a view of the set of stiffness curves of the wheel suspension system.

FIG. 15 is a diagram of the ratio between the rolling motion p and the number of interconnections N, whereby, as the number of side interconnections progressively increases, and the stiffness of the individual wheel remains constant, the rolling angle of the vehicle decreases.

FIG. 16 is a diagram of the ratio of the stiffness K to the number of interconnections N, which defines that as the number of interconnections progressively increases, the stiffness of each individual wheel decreases, while huntin or rolling stiffness, i.e. the total stiffness of the suspension behavior, remains unchanged.

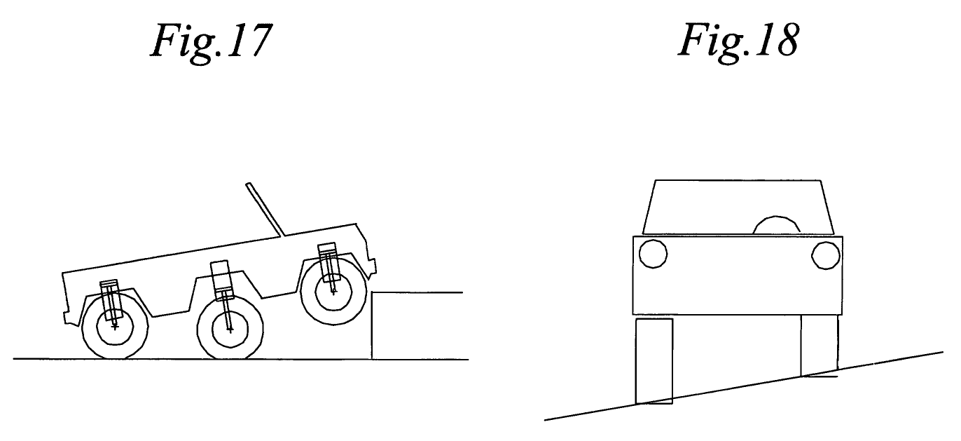

FIG. 17 is a schematic view of an example of further features of the invention, allowing the vehicle to pass over high obstacles and in which, thanks to the arrangements of the invention, the rear wheels are adjusted to a low position and the central wheels are adjusted to a high position.

FIG. 18 is a view of an operational variant, which provides a side slope, or anti-roll wheel adjustment.

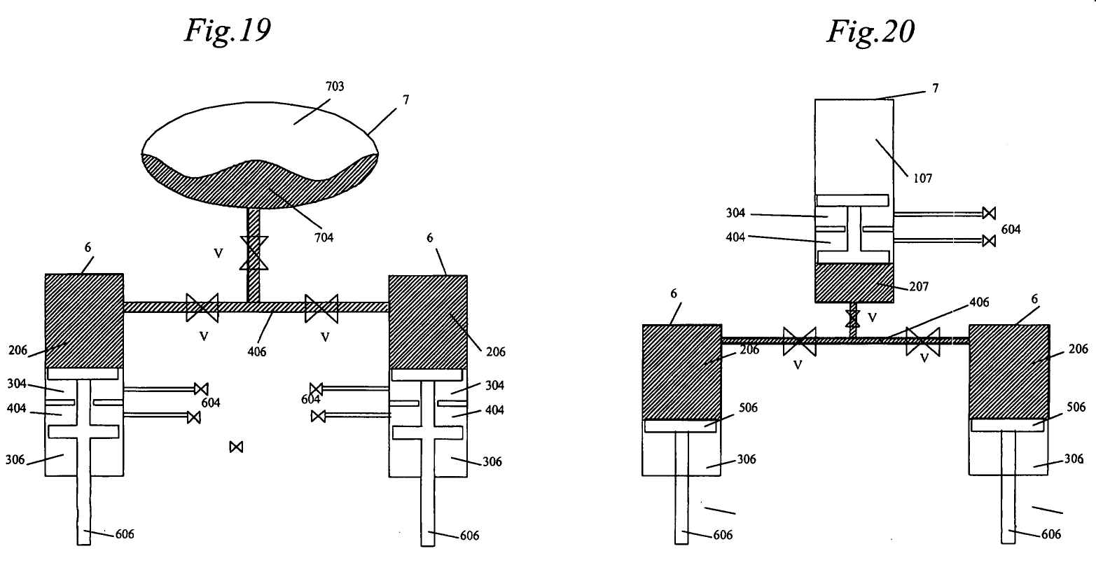

FIG. 19 is an embodiment of an actuator having an integrated anti-roll bar.

FIG. 20 is an embodiment of a main actuator having an integrated anti-roll bar.

With reference to FIG. 2, the latter shows a vehicle with a traditional independent wheel suspension system. Tires are numbered 2′ and 2″. The so-called non suspended mass, i.e. the complete mass of the wheel, hub and some of the elements of the suspension are numbered 3′ and 3″. The suspended mass, i.e. the chassis or the vehicle, including the passengers and the cargo is numbered 1, whereas the elastic suspension elements are numbered 105′ and 105″, and the brakes or shock absorbers are numbered 205′ and 205″. The reference numerals in use intend to show that the invention principle of the present invention is unrelated from the specific implementation technology, which may be of the mechanical, hydrodynamic, pneumatic type or made of a combination of these means.

As described above in greater detail, for this type of vehicle, the stresses exerted on a wheel affect the other wheels, toward reducing grip or changing the vehicle attitude in a non optimized manner. In order to provide a better attitude safety, in these conditions, the stiffness of the suspension 105′, 205′ and 105″, 205″ should be increased. However, a comfort reduction should be accounted for in this case. Comfort could be improved by reducing stiffness, which would determine motions like pitching, rolling or behaviors like yaws, etc., as described above, which impair the safety of the vehicle.

It shall be noted that in FIG. 2, and in FIGS. 3 to 7, as well as in FIG. 1, no specific position has been assigned to the wheels, and that wheels may be disposed either on opposite vehicle sides or on the same side and in different positions with respect to the longitudinal or transverse axis.

FIG. 1 shows the guiding principle of the invention, according to the graphical notation of FIG. 2. This model includes:

the two complete wheels, or non suspended masses 2′ and 2″, and their respective tires 3′, 3″, represented as elastic elements;

a main suspended mass suspending element 1, which includes one or more elastic elements 105 and one or more shock absorbers 205, connected between the chassis 1 of the vehicle and the wheel hubs;

means for interconnecting the two wheels, generally denoted as 4;

elastic opposing elements 103′, 103″ and corresponding shock absorbers 203′, 203″, interposed between each wheel and the chassis.

Thanks to this arrangement, any stress exerted on one of the two wheels 2′, 3′ and 2″, 3″ is at least partly discharged on the other intriconnected wheel/s.

This effect allows to effectively obviate the drawbacks of prior art suspensions, since it allows to maintain a high comfort level, i.e. a non excessive stiffness of the suspension system, by limiting or suppressing, according to adjustments or settings, the oscillatory movements or non optimal attitude variations, due to the lower stiffness of the suspension.

The arrangement of the invention, which may be implemented in several different manners, also allows to control the behavior of the vehicle as regards all oscillatory motions, like pitching, rolling or undesired motions like yaws, or motions of the chassis in braking conditions, hence to always provide the vehicle with the proper attitude in any drive condition.

The diagrams of FIGS. 13 to 16 show the operation of the suspension system of the vehicle according to the invention. FIG. 13 shows a set of curves of the total elastic action exerted on the wheel, i.e. the sum of the elastic actions of the support spring 105, of the opposing spring 103′, 103″ and of the spring or elastic action of the interconnection system and of all elastic elements, like 4, 304, 404. The above elements may be calibrated in such a manner that the total elastic action of the system remains linear and with the desired slope of the desired suspension bump range. Similarly, as shown in FIG. 14, within this zone a proper setting allows to maintain the stiffness of the suspension system, in the central bump range, at a minimum and substantially constant level.

Conversely, FIG. 15 shows that an increase of side interconnections reduces the oscillatory behavior (in this case rolling), with the suspension stiffness being constant.

FIG. 16 shows how the stiffness of the individual wheel decreases with the stiffness to hunting or vertical oscillatory motion of the vehicle being constant.

It shall be noted that, with the system of the invention, a smaller impact on the ground is obtained and that this lower, impact on the ground reveals a better traction and grip, particularly over a rough and slippery ground and a better comfort, due to a more even distribution of the forces acting on the chassis (1) which means a higher speed at the same comfort level.

FIG. 3 shows a variant embodiment of the invention, in which each wheel, denoted as m1, p1, m2, p3 has a corresponding elastic support element with an associated shock absorber 105′, 205′ and 105″, 205″, the interconnection 4 being provided between the two elastic support elements, whereas the elastic opposing element 103′, 103″ acts directly on the corresponding wheel.

A further variant of the vehicle according to the invention is shown in FIG. 4, representing an eight-wheel vehicle, each wheel being numbered 2 and 3 to denote the non suspended mass and the elastic component. Each pair of wheels has a common elastic suspension element 105′ and 105″ and an associated shock absorber 205′, 205″, and these elements act on an interconnection element 4′, 4″, which connects the two wheels of each pair with each other. This configuration shall be intended without limitation and as an exemplary selection amongst the multiple possible interconnection selections. Moreover, the elastic opposing elements, with any possible associated shock absorber are omitted for the sake of simplicity. As described below in greater detail, the particular use of fluid dynamic interconnection means provides high versatility in the manufacture of interconnections, which allow to implement a variety of configurations.

In the illustrated embodiments, the interconnection element or means 4, 4′, 4″ and all the other elements or means described hereinbefore with reference to the Figures are to be intended and interpreted based on the term definition provided at the start of the description.

FIG. 5 shows a variant of a vehicle according to the invention in which the interconnection means, including the elastic opposing elements and the associated shock absorbers consist of a hydraulic or pneumatic circuit and of a pair of linear actuators. Each wheel 2, 3 is further connected to the chassis 1 via an actuator 104′, 104″, whose piston 204′, 204″ divides the cylinder into two chambers 304′ and 404″; furthermore, the chambers of the two cylinders 104′, 104″ are connected with each other in a crossed or inverted manner through ducts 604′, 604″, having flow control valves, e.g. adjustable throttle valves. In these conditions, any action on a wheel causes the same tendency on the corresponding interconnected wheel. The flow control valves V allow to control stress response of the interconnection system.

FIG. 6 shows a variant of the vehicle of the invention and particularly of FIG. 1, in which the elastic suspension element 105 is formed by a fluid tight receiver 705, provided with a diaphragm 702 for separating two chambers 704, 703, whereof one contains a liquid, and the other contains a compressible fluid.

FIG. 7 shows a form of implementation of the interconnection principle according to FIG. 3, in which the opposing elements 103′, 103″ are actuators. In this specific case, the piston of each actuator divides it into two chambers, the wheel side chamber being filled with gas or fluid, and the other chamber 203′, 203″ being filled with a liquid and communicating with the chamber 704′, 704″ of a corresponding receiver 705′, 705″, which is identical to the receiver of the embodiment of FIG. 6. Each receiver 705′, 705″ has a diaphragm for separating the chamber 704′, 704″ filled with liquid and communicating with the corresponding chamber of the opposing actuator 103′, 103″, from the chamber 703′, 703″ filled with gas or other fluid. The chambers of the opposing elements 103′, 103″ are connected to the corresponding chambers 704′, 704″ of the corresponding receivers 705′, 705″ via a flow control valve, Moreover, the two receivers 705′, 705″ are connected to each other via a duct 408 which allows the two chambers 703′, 703″ filled with gas of said two receivers to be in communication with each other.

All the above elements form an embodiment of the interconnection of the two wheels according to the principle of FIG. 3. The receivers 705′, 705″ have the function of elastic suspension elements like in the embodiment of FIG. 6. Moreover, flow control valves may be provided in the duct 408 for connecting the chambers 703′, 703″ of the two receivers 705′, 705″. When, like in the previous example, a receiver 8 is further provided, the latter may be connected to the gas duct which interconnects the chambers 703′, 703″, via a flow control valve and the two additional flow control valves, when provided, are disposed on the two branches of the interconnection duct defined by the connection of the receiver 8.

The receiver 8 is used to maintain a certain predetermined pressure inside the gas-containing parts, or, when associated to a controllable on-off valve and possibly also to pressure generators, to change the dynamic characteristics of the hydraulic/pneumatic system.

FIG. 8 shows a more detailed implementation example, in which a vehicle is provided with a front-rear crossed anti-pitch/anti-roll bar fluid dynamic system. The intermediate axle, as outlined by the dashed frame, may or may not be present depending on whether the vehicle has six or four wheels. The drawing only shows the wheel nterconnection bar system. The illustrated system is derived from the basic system as shown in FIG. 5. Each wheel is provided with a linear actuator. In this particular example, only the actuators of the diagonally opposite interconnected wheels are numbered. Obviously, the following description will also identically apply to the other two diametrically opposite wheels and to the opposite wheels on the intermediate axle. Each actuator 5′, 5″ is composed of the cylinders 104′, 104″, which are divided into two chambers 304′, 404′, 304″ and 404″, by the piston 204′, 204″. The stem 504′, 504″ of each actuator 5′, 5″ acts on the corresponding wheel, and the chambers 304′ and 404′ and the chambers 304″ and 404″ are connected with each other, whereas flow control devices, denoted as V′, are provided in the connections, and said devices may consist of controllable flow control valves and may additional include means for pressure adjustment and/or temperature control of a fluid, particularly a gas.

The operation is essentially as described above.

FIG. 9 shows a variant in which the wheels of each side of the vehicle, with reference to the longitudinal axis thereof, are interconnected. Like in the previous example of FIG. 8, the pair of opposite wheels contained in the dashed frame may or may not be present, thereby identifying the four- or six-wheel configuration.

In the example of FIG. 9, in lieu of a main diaphragm receiver like in FIG. 7, there is provided a main linear actuator 7 , 7′ for the interconnection of each line of wheels of each side of the vehicle. The actuator 7, 71 has a piston 507 which divides the cylinder into two chambers, one chamber containing an elastic element which may be of the mechanical type 107 as shown in the Figure or a compressible fluid, particularly a gas. The other chamber 207 contains another fluid, particularly a liquid and communicates via a duct with as many chambers 206 of linear actuators 6 each associated to a wheel. The chambers 206 are designed to contain the liquid and are separated by a piston 506 from chambers 306 containing elastic opposing elements, which may be of the mechanical type, as shown, or consist of a compressible fluid, especially of a gas or a combination thereof. The piston 506 of each actuator 6 is fixed to the wheel by means of a stem 606.

In FIGS. 8 and 9, the actuators are schematically shown as being parallel to the axis of the wheels. In fact, they have to operate with the pistons perpendicular to the axis of the corresponding wheels, i.e. vertically or by means of a lever system which changes the wheel direction into the desired direction of the piston. The graphical notation in use further clarifies the construction of the system.

FIGS. 10 and 11 show the vehicle of the invention according in a more complete and complex embodiment. An eight-wheel vehicle suspension configuration is provided, having both anti-roll bars and interconnections of the wheels on each side. In this embodiment, the two arrangements of FIGS. 8 and 9 are integrated and, corresponding elements or functions are numbered identical to those used in said FIGS. 8 and 9.

The embodiment relates to an eight-wheel vehicle. Each wheel has its own actuator 6 which communicates with a cylinder 7 having a liquid containing chamber 207 separated from a gas containing chamber 307 by a piston 507. The piston 507 has a structure including additional intermediate chambers 607 which are connected to a pressurized gas circuit, supplied via separate supply lines. Each pair of wheels of each side, from the total of eight wheels, is associated to a cylinder 7 and an actuator 6 is associated to each wheel of each pair. The gas supply circuit includes a receiver and a compressor to adjust circuit pressure and the individual branches for connection to the intermediate chambers 607 of the pistons 507 of the cylinders 7 have servo-controllable flow control valves. Moreover, the chambers 307 and 607 of the pistons 7 are cross-connected to each other with reference to the pair of wheels whereto they are associated. The interconnections are also provided with flow control valves V.

This embodiment relates to a system which, as mentioned, includes both interconnections with pairs of wheels on the same side and interconnections that are designed to generate anti-roll bars and provides an integration of the embodiments of FIGS. 8 and 9 as well as of the basic embodiment of FIG. 4. Here, interconnections are of the pneumatic type for anti-roll bars and of the hydro-pneumatic type for wheels connected on the same side of the vehicle.

In such a system, the adjustments of the system and particularly of servo-controllable valves, as well as pressure and temperature control and any possible vehicle attitude control must be controlled by an electronic unit. A computer 20 or a microprocessor provides the basis for controlling the functions of a dynamic, manual or automatic control unit 21 for the suspension system via a control line. The unit 21 may be associated to a display 22 for displaying the scheme of the relevant vehicle and wheels; moreover, danger and setting indicators may be provided, which may also be indicators/buttons of default settings for using the vehicle in several different preset situations, e.g. optimized comfort, minimized comfort, off-road attitude, maximized safety attitude, etc. The computer is connected to the data logger 23 and to the control unit via data lines for transmitting to the computing software all data collected by sensors of pressure P, temperature T, attitude L and any other sensors, such as accelerometric sensors, etc.

Further, the control unit 21 has control outputs connected to servo-controllable valves V and other devices such as the compressor, etc.

Obviously, an integrated electronics may be used instead of the computer 20, said elements being separated in the illustrated example, for a better functional clearness.

Obviously, the control system may include any other currently available data and/or command entry, display and warning means, such as keyboards, printers, displays, chipcards, etc.

The example of FIG. 12 shows a further embodiment of a six-wheel vehicle with interconnections between the wheels of each side. Here, interconnections are provided like in the example of anti-roll bars of FIG. 8, whereby each wheel has an actuator cylinder 5′, 5″ with a piston 204′, 204″ which divides the cylinder into two chambers 304′, 304″ and 404′, 404″, the corresponding chambers of each cylinder being connected to each other via connections having flow control valves V′.

FIGS. 17 and 18 show a few possible extreme applications of the vehicle according to the invention, particularly with reference to the configuration of FIG. 12. In FIG. 17, the attitude has been changed by lifting the central wheels and by lowering the rear wheels. By this arrangement, the passage over high obstacles is facilitated, because front wheels are lifted from the ground to a better position with respect to the obstacle. In FIG. 18, attitude correction has been made by lowering the upstream side wheels and lifting the downstream side wheels. It shall be noted that FIGS. 17 and 18 show two extreme applications of the features of the suspension system of the vehicle of the invention.

FIGS. 19 and 20 show two interconnection embodiments.

Referring to FIG. 19, a receiver 7 with a diaphragm for separating two chambers 704 for a first fluid, particularly a liquid, and 703 for a second fluid, particularly a gas is connected to two actuators 6, i.e. to the chambers 206 of said actuators. A piston with a stem 606 divides the cylinder into three more chambers 304, 404, 306 in combination with an intermediate stationary wall. The individual chambers are designed to contain a fluid or several different fluids supplied from the outside via suitable ducts 604 and/or interconnected according to arrangements described above, like the arrangement of FIG. 5, wherein the chambers 304 and 404 are cross-interconnected, parallel to the vehicle support system, or sealed from the inside.

Conversely, in the variant of FIG. 20, the actuators 6 are as described above, whereas the receiver 7 is replaced by a cylinder having a piston or a movable interior wall which divides the cylinder into four chambers 207, 304, 404, 107 in combination with a fixed wall. The chambers 304, 404 have inlet or outlet connection ducts 604. The chamber 207 is connected to the chambers 206 of the actuators 6 via the duct 406, which is provided with valves V.

Referring to the previous embodiments, when the interconnection is provided via ducts having interconnection valves, by closing the interconnection valves the stiffness of suspensions increases, and particularly when the valves are closed completely, the stiffness of each wheel will be increased as a function of the pressure within the chambers 304, 404 and of the volume thereof, including the volume of connections. Hence, this may be a method to instantaneously change the stiffness of suspensions by means of an on-off valve.

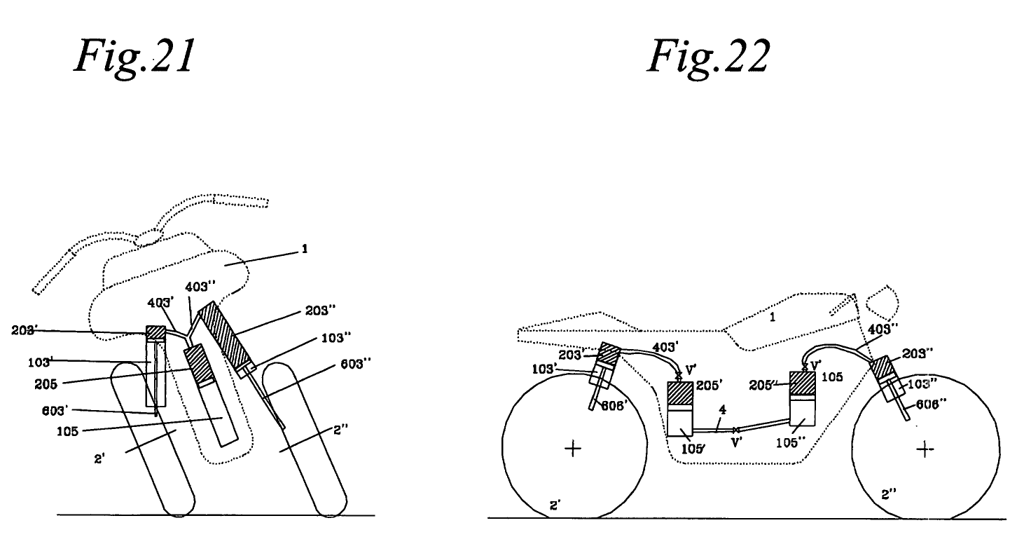

In the variant of FIG. 21, a motorcycle with a two-wheel axle 2, 2′ is shown having any type of kinematic wheel driving system, which tilt with the vehicle but have, thanks to the interconnection action, the wheel supported substantially with similar forces; in fact, the fluid in the chamber 203′ flows into the chamber 203″ through the ducts 403′, 403″ and the elastic elements 103′, 103″ oppose the elastic element 105, and may also communicate with each other via a duct, which is not shown. Then the elements 603′, 603″ are connected directly or indirectly to the corresponding hubs of the wheels 2′, 2″.

Also, the ducts 403′ and 403″ may have an on/off valve which stops, for instance, the motorcycle in the vertical position for stand-less parking or upon braking or driving at a very low speed to maintain equilibrium without having to put the feet on the ground.

In the variant of FIG. 22, a motorcycle is shown, which has an interconnection system as shown in FIG. 3. Particularly, forces equal to the sum of the elastic elements 105′, 105″ and of opposing elements 103′, 103″ are exerted on the elements 606′, 606″, connected to the kinematic system of the corresponding wheels 2′, 2″, through the hydrodynamic circuit 405′, 403″ which connects the chambers 203′, 205′ and 203″, 205″ respectively, whereas the duct 4 interconnects the elastic support elements 105′ and 105″. The valves V′, V″ form the damping system, hence have the function of shock absorbers when they control the fluid flow whereas, when the valve V″ is closed, it separates the two suspensions which, in this case, are disconnected and behave like traditional suspensions.

1. A vehicle comprising a frame or chassis (1) having at least two preferably independent wheels (2, 2′), whose hubs, driven by any kinematic system, are connected to a hydraulic, mechanical, pneumatic, electric or magnetic system (4) or a combination thereof, which interconnects these hubs with at least one elastic vehicle supporting element, so that the stress responses acting on a wheel are at least partly transferred to the corresponding connected wheel/s.

2. A vehicle as claimed in claim 1, characterized in that the suspensions of the vehicle have elastic elements (103, 103′) which act on each hub and have the function to oppose the elastic element/s (105) for supporting the vehicle weight.

3. A vehicle as claimed in the preceding claims, characterized in that shock absorbing elements (203, 203′, 205) are provided which act directly or indirectly on the elastic elements (103, 103′, 105) to dampen oscillations and stabilize the vehicle.

4. A vehicle as claimed in one or more of the preceding claims, characterized in that the reduction of the rolling and/or hunting motions of the vehicle is obtained by means of a system for suspending the chassis (1) which uses at least two double acting linear actuators (5′, 5″) connected in parallel to the suspensions and disposed on the same side and/or on the same axle of the vehicle, and characterized in that said actuators are interconnected, directly or indirectly, via ducts (604′, 604″) which connect the corresponding chambers (304′) with (304″) and (404′) with (404″).

5. A vehicle as claimed in one or more of the preceding claims, characterized in that each of the linear actuators (5′, 5″) consists of a cylinder (104′, 104″) connected, directly or indirectly, to the frame and of a piston (204′, 204″) connected to the hub of the vehicle wheels by means of a connection element (504′, 504″) and wherein the cylinders (104′, 104″) are divided into two chambers (304′, 404′, 304″, 404″) by said piston, each of said two chambers containing a pressurized fluid, and characterized in that each of the two chambers (304′, 404′, 304″, 404″) of each linear actuator (5′, 5″) is connected via ducts (604′, 604″) to the chamber of the other linear actuator (5′, 5″) in an inverted manner, so that the compression of a linear actuator (5′, 5″) causes a corresponding movement in the other linear actuator (5″, 5′).

6. A vehicle as claimed in one or more of the preceding claims, characterized in that the suspensions of the vehicle are assisted in parallel or in series by anti-roll/anti-pitch systems, consisting of two linear actuators (5′, 5″), which are cross-connected on opposite sides of the vehicle, the actuator (5′) disposed on a front side of the vehicle being connected with the actuator (5″) disposed at the rear, on the opposite side of the vehicle as related to the first actuator, and the other two front and rear linear actuators being connected accordingly.

7. A vehicle as claimed in one or more of the preceding claims, characterized in that it has a mechanical, hydraulic, manual, electronic or other system, or a combination thereof, that changes the relation between the wheels according to dynamic conditions, i.e. pitching, rolling, hunting, of the vehicle, e.g. so that a braking action by the driver acts on the combination of the connections to increase the stiffness of the front axle.

8. A vehicle as claimed in one or more of the preceding claims, characterized in that the system for damping the oscillations of the suspended mass, which uses the fluid dynamic interconnections of actuators (5′, 5″) is used in combination with or alternatively to the shock absorbers of traditional suspensions.

9. A vehicle as claimed in one or more of the preceding claims, characterized in that adjustable flow control valves (V) are provided on the ducts (604′, 604″) for connecting the chambers of the linear actuators (5′, 5″).

10. A vehicle as claimed in one or more of the preceding claims, characterized in that the suspensions of the vehicle are made of linear actuators (6), wherein the chamber/s (206) is/are connected hydraulically, through the ducts (406, 407) to an elastic support element (107), whereas the effect of opposition to the vehicle weight supporting force is provided by the elastic element (106).

11. A vehicle as claimed in one or more of the preceding claims, characterized in that the duct (407), which is connected at one end to the duct (406), is connected to the linear actuator (7) via an adjustable valve (V).

12. A vehicle as claimed in one or more of the preceding claims, characterized in that the actuator (7) consists of a receiver having a hydro/fluid separating diaphragm.

13. A vehicle as claimed in one or more of the preceding claims, characterized in that the linear actuators (6′, 6″) are hydraulically connected to the actuator (7) which is in turn fluid dynamically interconnected between at least two connected chambers of the elastic elements (703′, 703″) via ducts (408).

14. A vehicle as claimed in one or more of the preceding claims, characterized in that, as an alternative thereto or in combination therewith, adjustable valves (V) are provided on one or more connection ducts (406, 408).

15. A vehicle as claimed in the preceding claims, characterized in that at least one additional pneumatic receiver (8) is connected to the duct (408).

16. A vehicle as claimed in one or more of the preceding claims, characterized in that, on the elastic elements of the actuators (6, 7), means are provided to change the physical characteristics thereof, i.e. stiffness, by changing the volumes and/or pressures of the vehicle weight supporting and/or opposing chambers (204′, 304′, 204″, 304″, 107, 106′, 106″), by any type of hydraulic, mechanical, pneumatic or electromagnetic system, or a combination thereof, preferably controlled by a suitable control electronics.

17. A vehicle as claimed in one or more of the preceding claims, characterized in that the pressures of the elastic elements (107, 103, 304, 404, 8) are connected, via suitable valves, to a pressure source, e.g. a compressor, and the manual or electronic control of these valves allows to change statically and/or dynamically all the attitude characteristics of the vehicle.

18. A vehicle as claimed in the preceding claim, characterized in that said valves (V) form a multiple-way interconnection system, which can provide all interconnections between the various chambers of the double acting linear actuators (5, 6, 7, 8).

19. A vehicle as claimed in one or more of the preceding claims, characterized in that the control valves (V, V′) are controlled by any mechanical, hydraulic, pneumatic or electromagnetic system, or a combination thereof, which changes its section and/or characteristics, preferably in a continuous and/or fuzzy manner.

20. A vehicle as claimed in one or more of the preceding claims, characterized in that the vehicle is stabilized by means of a preferably electronic control system, which is connected to the suspension system via appropriate vehicle oscillation measuring sensors (L), wherein said sensors (L) are provided with a special connecting interface and send the detected signals to an electronic computer for processing, to determine the corrective actions that have to be sent to the actuators (5, 6, 7) via the control solenoid valves (V, V′), which are interfaced with a computer which changes the interconnection combination and/or adjusts the pressures and/or the volumes of the chambers (306, 307, 8, 304, 404) and/or the fluid flows.

21. A vehicle as claimed in one or more of the preceding claims, characterized in that the corrective actions sent by the electronic computer to control solenoid valves (V, V′) via an appropriate interface may be automatically determined by the computer thanks to programs for calculating the vehicle dynamics from motion equations, while accounting for the physical characteristics of the vehicle, ground conditions, the desired comfort conditions and other useful parameters, or be manually preset by the driver.

22. A vehicle as claimed in one or more of the preceding claims, characterized in that several different corrective actions may be set on the electronic computer, to be implemented in case of oscillations of the suspended masses of the vehicle or of an individual suspension and/or for particular attitudes.

23. A vehicle as claimed in one or more of the preceding claims, characterized in that the stiffness of a single interconnected suspension, relative to the individual motion thereof, is proportional to the ratio of its own non interconnected stiffness (R) to the total number of connected suspensions of the vehicle (N), i.e. R/N.

24. A vehicle as claimed in one or more of the preceding claim-ms characterized in that the connection configurations of the valves (V, V′) is such that all the suspension on one side are interconnected.

25. A vehicle as claimed in one or more of the preceding claims, characterized in that, in order to obtain a better vehicle stabilization in any condition, a system for stabilizing the temperature of the fluid or gas contained in the whole vehicle suspension system may be introduced, by using sensors (T) interfaced with the system for controlling the oscillations of the suspended mass of the vehicle, which performs such corrective actions, e.g. by adjusting the fluid temperature or pressure, as to allow the suspension operation to be essentially independent from temperature.

26. A vehicle as claimed in one or more of the preceding claims, characterized in that the total stiffness to force ratio at the hub, i.e. the sum of the elements is such that a family of stiffness to force curves may be generated, with respect to the bump range of the wheel, which substantially extends from linear slope curves, such as for a helical spring, to curves characterized by a higher slope in the bounce and compression zones as compared with the central suspension shaking zones.

27. A vehicle as claimed in one or more of the preceding claims, characterized in that by changing the pressures and/or volumes of the chambers (304, 404) of the actuator (5), the stiffness of each wheel also changes without affecting the stiffness to hunting or vertical accelerations.

28. A vehicle as claimed in one or more of the preceding claims, characterized in that the force of the elastic opposing element is greater than the weight of the corresponding non suspended mass.

29. A vehicle as claimed in one or more of the preceding claims, characterized in that the change of pressures and/or volumes (107) and/or (103), i.e. of the elastic supporting and or opposing elements cause a number of possible attitude changes, like:
changes of the height of the vehicle from the ground
change of the rolling angle, even opposite to the centrifugal force
compensation of side slopes
compensations of load distributions
ability to pass over obstacles, e.g. in 6 or more wheel vehicles, by lifting the side which faces the obstacle and by lowering the opposite side.

30. A vehicle as claimed in one or more of the preceding claims, characterized in that the combination of interconnections minimizes the impact on the ground, i.e. it is such that each wheel has simultaneously a minimized impact on the ground, both dynamically and statically, with respect to load distribution and to dynamic conditions.

31. A vehicle as claimed in one or more of the preceding claims, characterized in that it comprises a part or all of the characteristics as claimed in claims 1 to 31.
